(19) United States
(12) Patent Application Publication
(10) Pub. No.: US 2006/0072879 A1
(43) Pub. Date: Apr. 6, 2006

(54) Optical fiber polishing method

(76) Inventors: Lizhang Yang, Austin, TX (US); Sergio D. Carranza, Cedar Park, TX (US); Vern E. Radewald, Austin, TX (US)

Correspondence Address: 3M INNOVATIVE PROPERTIES COMPANY, PO BOX 33427, ST. PAUL, MN, 55133-3427, US

(21) Appl. No.: 10/954,453

(22) Filed: Sep. 30, 2004

(51) Int. Cl. G02B 6/36

(52) U.S. Cl. 385/85; 385/76; 385/78

(57) ABSTRACT

Disclosed is a method for polishing a multi-fiber ferrule assembly and the optical fibers protruding from the ferrule using at least one particle loaded film, at least one slurry, and at least one flocking film.

### TECHNICAL FIELD

This invention relates in general to methods for polishing a ferrule assembly. More particularly, the method relates to polishing protruded fibers in multi-fiber ferrule connectors.

### BACKGROUND

Polishing of MT ferrules and MT ferrule assemblies is well known in fiber optic connector manufacturing. The polishing of the fibers and ferrules may improve the transmission of the light signal through the mated fiber optic connector. Examples of such multifiber connectors are MTP from US Connec, MPO from Furukawa, and OGI from 3M Company.

### SUMMARY

At least one aspect of the present invention provides a method that achieves tightly controlled tolerances for optical fiber protrusions and fiber protrusion differentials. Another aspect of the invention is to eliminate the backcut step in MT multimode polishing processes for improved cosmetics and improved protrusion length differential.

One aspect of the present invention provides a method for providing a ferrule assembly having a front side, the front side comprising a ferrule having a front face and at least one optical fiber extending through the ferrule such that an end portion of the at least one optical fiber is exposed through the front face of the ferrule; and (a) polishing the front side of the ferrule assembly with a particle-loaded lapping film to bring the fibers substantially flush with the ferrule front face; (b) polishing the front side of the ferrule assembly with at least one slurry to create fiber protrusion; and (c) polishing the front side of the ferrule assembly with at least one flocked film to preferentially etch the at least one optical fiber relative to the front face of the ferrule thereby decreasing the length of the fiber protruding from the ferrule.

In one embodiment, the step of providing a ferrule assembly further includes the substep of removing any optical fiber portion extending beyond the front face of the ferrule by polishing the front side of the ferrule assembly with a rigid substrate containing diamond particles. In at least one embodiment, the substep is carried out as a dry process.

In another embodiment, the flocked film includes filaments having particles attached thereto. In at least one embodiment, the particles have an average diameter of about 1 μm to about 0.1 μm.

In another embodiment, step (a) is carried out as a wet process.

In another embodiment, step (a) further includes a plurality of polishing substeps, each substep using a lapping film with particles having a decreasing or equal average sizes.

In another embodiment, step (a) further includes the polishing substeps of: polishing the front face with a lapping film having a first particle type attached thereto; and polishing the front face with a lapping film having a second particle type attached thereto.

In another embodiment, step (b) further includes a plurality of polishing substeps, each substep using a slurry with particles having a decreasing average size.

In another embodiment, step (b) includes using a slurry with small diameter particles in combination with using a high polishing force per ferrule. In at least one embodiment, the diameter of the particles in the slurry is from about 2 μm to about 0.5 μm. In at least one embodiment, the polishing force per ferrule on a plurality of ferrules is from about 0.4 lbs to about 1.2 lbs.

In another embodiment, step (b) further includes the substeps of: polishing the front face with a slurry having a first particle type attached thereto; and polishing the front face with a slurry having a second particle type attached thereto.

In another embodiment, step (c) is carried out as a wet process.

Another aspect of the present invention provides an article made by a method of the invention including a ferrule assembly having a front side, the front side comprising a ferrule having a front face and at least one multi-mode optical fiber extending through the ferrule, wherein the fiber has a substantially flat core.

In one embodiment, at least one such ferrule is used in a mated ferrule assembly.

In another embodiment, at least one such ferrule is used in a fiber optic connector.

In another embodiment, at least one such ferrule is used in an optical device.

An advantage of at least one embodiment of the present invention is that it improves the control of optical fiber protrusion height and fiber protrusion differentials, which reduces mating forces required to make robust fiber connections.

It is to be understood that both the foregoing general description and the following detailed description are exemplary and explanatory only and are not restrictive of the invention as claimed.

The accompanying drawings, which are incorporated in and constitute a part of this specification, illustrate several embodiments of the invention and, together with the description, serve to explain the principles of the invention.

### BRIEF DESCRIPTION OF DRAWINGS

FIG. 1 is a perspective of an illustrative ferrule assembly according to the present invention having a ferrule and a plurality of optical fibers extending beyond an end face thereof;

FIG. 2 is an exaggerated perspective of the ferrule assembly in FIG. 1 after polishing of the ferrule end face;

FIG. 3 is a cross-sectional view of the ferrule assembly of FIG. 1;

FIG. 4 is a flow chart illustrating the polishing method for an optical fiber in accordance with the present invention;

FIG. 5 is a top view of a polishing apparatus which illustrates a polishing fixture adapted to retain a plurality of ferrule assemblies; and

FIG. 6 shows fiber protrusion measurements for forty different 24-fiber MT ferrules polished according to a method of the present invention.

FIGS. 7a-7d are illustrations of cross-sectional views of protruded fiber profiles.

### DETAILED DESCRIPTION

In at least one aspect of the present invention, the face of a ferrule is preferentially etched relative to the optical fibers in the ferrule in a controlled manner such that the optical fibers protrude beyond the front face of the ferrule. At least one aspect of the present invention is particularly advantageous for use with ferrules having multiple fibers (e.g., 24 or greater) because it provides uniform fiber protrusions, which reduces the force needed to bring all the optical fibers into physical contact with their mating fibers in a connector.

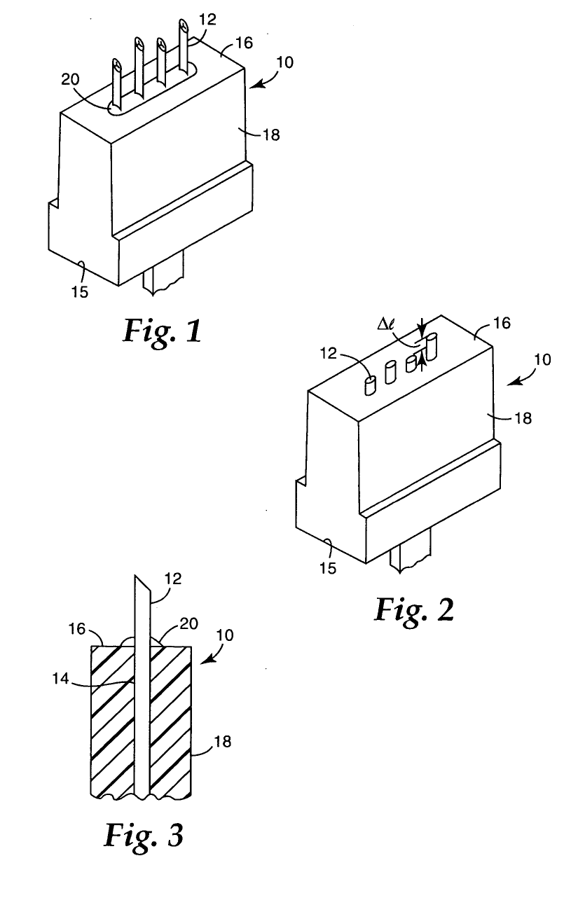

Referring to FIGS. 1 to 3, a ferrule assembly 10 is shown (greatly enlarged) with optical fibers 12 (which may be single or multi-mode) extending through holes 14 from a rear face 15 through a front face 16 of an MT ferrule 18. In at least one embodiment, the fibers 12 are inserted into MT ferrule 18 using an epoxy adhesive such that the fiber tips protrude through the epoxy bead 20 on the endface of the ferrule. An MT ferrule with four optical fibers is shown in the figures. It is to be understood that any number of fibers (and holes in ferrule 18), including, for example, MT having at least four fibers, are within the scope of the present invention. For example, the method is suitable for high density optical fiber connectors containing 24 or more fibers. The adhesive bead created in a ferrule having multiple rows of fibers is typically larger than those created in a ferrule having a single row of fibers.

Excess lengths of fiber extending beyond the surface of the adhesive bead may be shortened by known scoring and subsequent polishing processes. The epoxy bead containing the fiber ends can be removed by rough or aggressive polishing. However, in ferrules containing multiple rows of fibers, scoring fibers to remove bare excess fiber is difficult. Controlling the length of fiber extending from the ferrule surface to within or near the surface of the adhesive bead during mounting can eliminate the need for scoring the fibers in favor of an initial rough polishing step.

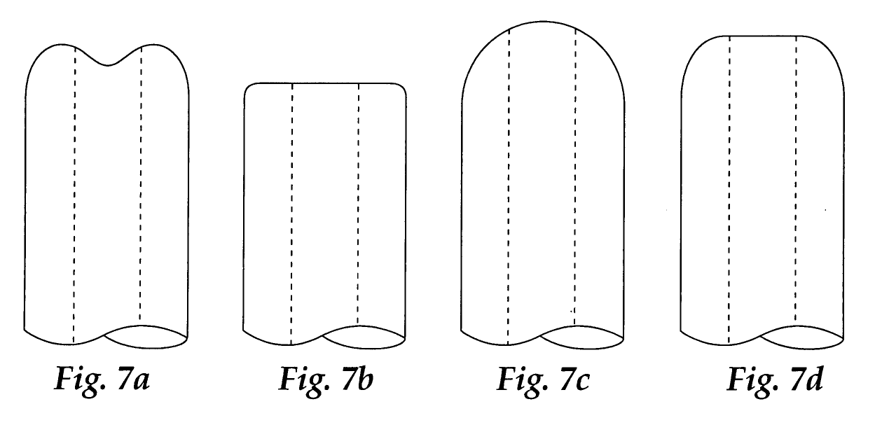

Core-dip is one common imperfection in the endface of multimode fiber connectors after polishing. It is commonly believed that the doping of optical fiber cores results in different mechanical properties in the core glass when compared to the cladding glass material. The differences in the mechanical properties result in different polishing behaviors of the core and cladding materials resulting in excessive removal of the core glass creating a “core dip,” as shown in FIG. 7a. Core dip will result in an air gap between a mated pair of fibers, which is detrimental to connector performance. To eliminate this undesirable core dip, a back-cut step is usually adopted to create a “flat” fiber end finish, as shown in FIG. 7b. This process is widely used in single fiber connectors polishing as well as multi-fiber connector polish. However, this back-cut step can cause problems. For example, for MT connectors, this step usually has very short polishing time with very little force, which results in a process that is very difficult to control. This back cut process reduces protrusion length, can result in greater fiber protrusion differentials, Δl, and may create poor fiber endface cosmetics. High protrusion differentials and low fiber protrusions are detrimental to the performance and stability of a mated connector, and poor endface cosmetics are unacceptable in a polished connector. The current invention describes a well-controlled MT ferrule fiber polishing process that eliminates the creation of core dip without the additional backcut step. The process of the present invention is more robust and produces a final product with improved performance and fiber endface cosmetics.

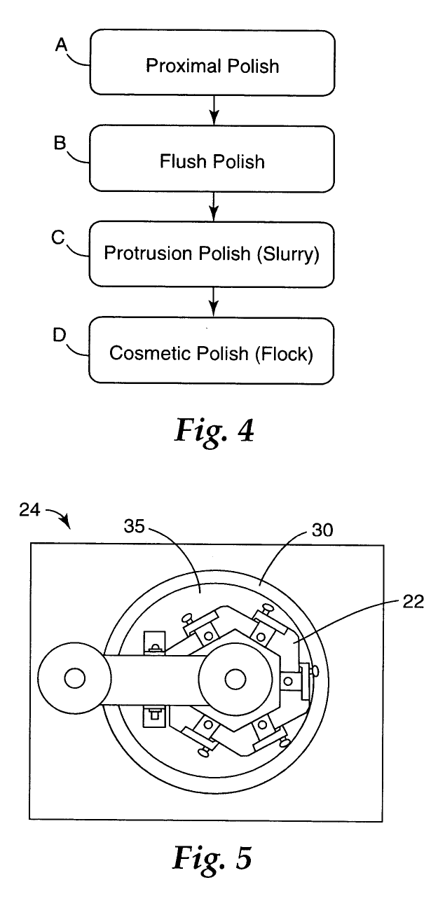

As shown in block A of FIG. 4, after the fibers 12 are secured in the ferrule 18, the protruding optical fibers may optionally be polished with one or more wet or dry diamond disk(s) to bring the fibers 12 into close proximity to the ferrule face 16 in a proximal polishing step. In this step, at least a substantial portion of the epoxy bead is removed. Typically this polishing step is done by hand using diamond particles bonded onto metal disk or a lapping film having a large particle size (e.g., greater than 15 μm). The size of the diamond particles on the disk may vary as is appropriate for the particular polishing process. Optionally, a second diamond polishing may be done to reduce the surface roughness. The size of the diamond particles will typically be reduced for each subsequent polishing step. In most cases, the diamond particles have diameters of about 5 μm to about 50 μm. Suitable diamond-loaded disks are available from 3M Company, St. Paul, Minn. This diamond polishing step can eliminate the need for scoring and breaking the fiber, which is difficult to perform with multi-row MT connectors. Materials that may be used instead of diamond for this step include, but are not limited to are examples of materials that may be used instead of diamond may be used silicon carbide (SiC), aluminum oxide (AlOₓ), cerium oxide (CeO₂), or silica (SiO₂).

After any initial hand polishing steps are performed, the ferrule assembly 10 is inserted into, and further polished with, a polishing apparatus 24, such as the one illustrated in FIG. 5. While the jig 22 of illustrated apparatus 24 holds six ferrules, a jig may be designed to hold any number of ferrule assemblies 10 so that multiple ferrules may be processed simultaneously. A suitable jig is available from Domaille Engineering, Rochester, Minn. Suitable polishing apparatuses are more fully described in U.S. Pat. Nos. 5,743,785 and 6,106,368.

When the ferrule assembly 10 is loaded into a jig 22 on the polishing apparatus 24 with the front face oriented toward the polishing disc 30, the optical fibers may be oriented at an angle to achieve a desired front face angle on the fibers. If a flat front face is desired, the fibers may be mounted about 90° relative to the surface of the polishing disc of the polishing apparatus. The loaded ferrule assembly 10 can then be lowered to engage the polishing disc 30 and more particularly, a polishing medium 35 removably attached to the polishing disc 30. The polishing disc rotates about a disc axis and orbits (oscillates) about an eccentric axis, which is offset from the disc axis. The dual motion of the disc 30 relative to the ferrule assembly 10 allows not only for polishing of the ferrule front face 16 by new portions of the polishing medium 35 (rotation), but also polishing from different directions to prevent edge effects (orbiting/oscillation).

In the polishing apparatus 24, the ferrule assembly 10 is polished according to the next step as shown in block B of FIG. 4, in which at least one wet or dry polishing step is carried out using a particle-loaded lapping film to polish the fibers substantially flush with the ferrule surface and to reduce the surface roughness. If two or more polishing steps are carried out, each subsequent polishing sub-step may use media with the same, or decreasing, particle sizes. The particle size may be bigger than or smaller than the particle size of the final diamond polishing step, but it is usually smaller. Suitable polishing media include polishing films of SiC, CeO₂, AlOₓ, diamond, or SiO₂ films. Suitable particle sizes range from about 30 μm to about μm, and are typically from about 16 μm to about 3 μm in diameter. An exemplary particle-loaded lapping film is loaded with 15 μm SiC available under the trade designation 468X from 3M Company, St. Paul, Minn. Suitable polishing pressures range from about 1.5 lbs (6.67 N) to about 5 lbs (22.24 N), in addition to the weight of the jig 0.91 lb (4.05 N) for a ten-ferrule jig. A typical force setting of the polishing machine is about 3.3 lbs (14.68 N), or 0.42 lbs per ferrule (1.87 N per ferrule) including the weight of the jig. Suitable platen speeds are about 100 rpm to about 150 rpm, typically about 120 rpm. Polishing times are typically around 50 to 120 seconds per sub-step.

Subsequently, as shown in block C of FIG. 4, a protrusion producing polishing step is carried out using one or more slurry polishing steps with small particles and a high polishing force. The slurry preferentially removes the ferrule material relative to the optical fibers 12, but it also polishes the optical fibers 12. The free floating slurry particles wear away the softer ferrule material faster than the harder glass of the optical fiber thus producing protrusion. The slurry may contain, for example, aluminum oxide (AlOₓ), CeO₂, or Sio₂. Suitable particle sizes are about 2 μm to about 0.05 μm in diameter. An example of a slurry is an aqueous slurry containing about 20 wt/wt % μm aluminum oxide particles, available under the trade designation ALPHA Micropolish (II) 1.0 micron alumina, from Buehler, Lake Bluff, Ill. Suitable polishing pressures range from about 4 lbs (17.79 N) to about 12 lbs. (53.38 N), and are typically about 10.9 lbs (48.48N) with a platen speed typically in the range of about 100 to about 200 rpm, often about 150 rpm and polishing times are typically greater than 200 seconds, often about 400 seconds. The combination of using small particle sizes and high polishing pressures helps to achieve small height differentials among the fibers being polished with the desired protrusion length. If more than one slurry is used, typically the particles used in subsequent slurries are smaller than those used in previous slurries.

Finally, as shown in block D of FIG. 4, the ferrule assembly is wet or dry polished with one or more flocked films (i.e., a material having small filaments extending upwardly from a base material with small abrasive particles attached thereto). The flocked film polishes the optical fibers 12 to enhance endface cosmetics. This polishing of the endface results in a slight, but controllable reduction in the protrusion length without altering the protrusion differential. Suitable particles for the flocked film include cerium oxide, silicon oxide, and aluminum oxide particles. Suitable particle sizes are about 1 μm to about 0.1 μm in diameter. If more than one flocked film is used, typically the particles used in subsequent flocked film are smaller than those used in the previous flocked films.

Suitable polishing pressures range from about 0.2 lbs per ferrule to about 0.9 lbs per ferrule, and are typically about 0.59 lbs per ferrule or 5.9 lbs per jig (26.24 N) with a platen speed typically in the range of about 100 to about 200 rpm, often about 175 rpm and polishing times are typically in the range of about 80 to about 180 seconds, often about 150 seconds. An exemplary flocked film is loaded with 0.5 μm cerium oxide particles, available under the trade designation 589X, from 3M Company, St. Paul, Minn. The use of other compliant, resilient materials having abrasive particles attached thereto would also be suitable for use during the flocking step. For example, a suitable material would be a synthetic leather material (a porous polyurethane loaded with fused alumina having an average size of 3.025 μm) available under the trade designation part number AO-3-66-SW from Mipox, Hayword, Calif. Ferrules and their fibers polished by the method of the present invention have been shown to require significantly less mating force to achieve physical contact than fibers polished by standard polishing methods. Ferrules and fibers polished by the method of the present invention exhibit low protrusion differentials, thereby allowing better mating (e.g., less back reflection, insertion loss, etc.) with each of the optical fibers in a similar ferrule assembly.

A three-step polishing process was used to polish 24 fiber MT ferrule as baseline samples. First, a series of lapping films was used with decreasing mineral sizes to create a flat ferrule surface with low surface roughness, for example: 15 μm SiC lapping film polishing followed by 5 μm SiC lapping film polishing. Then, a 3 μm aluminum oxide slurry on a Nylon pad was used to create optical fiber protrusions, and finally a 0.05 μm AlOₓ lapping film was used in the backcut step to eliminate the core-dips. This general process is a popular process in the industry to polish multimode MT connector when the ferrule material is glass filled thermoset epoxy. The average protrusion differential in the resulting connectors was about 0.38 μm. requiring a high mating force (greater than 4 lbs or 17.79 N) to achieve physical contact between all of the optical fiber pairs. This high mating force is not acceptable for many connector applications.

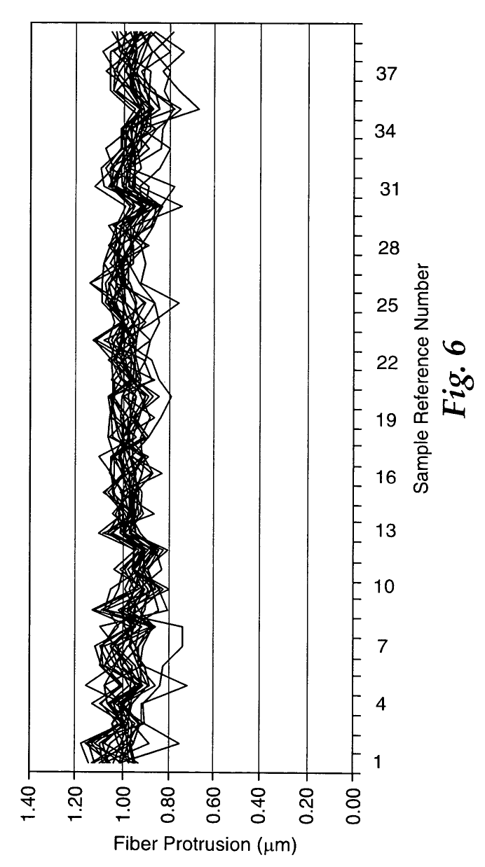

FIG. 6 shows protrusion data from forty different 24-fiber MT ferrules polished using a method of the present invention. The protusion was measured using a Norland Interferometer (available from Norland Products, Inc., Cranbury, N.J.). The x axis is an arbitrary Sample Reference Number. The y axis is the fiber protrusion length. For ferrules containing up to 24 fibers, the average protrusion differential is only about 0.25 μm. As a result of this lower differential, the mating force needed to achieve physical contact for all of the fibers is only about 2.3 lbs (10.23 N), as compared to the previously required more than 4 lbs (17.79 N).

When polishing a multi-mode fiber, traditional polishing processes preferentially etch the softer optical fiber core material relative to the glass cladding, which results in core dip. The core-dip problem is usually corrected by performing an additional back-cut step using a hard polishing film with fine polishing minerals (typical mineral size smaller than 0.5 micron) to even the optical fiber surface. This additional step can be hard to control and is problematic in that it reduces the fiber protrusion.

According to an embodiment of the present invention, in flock and slurry polishing, the edges of the protruding fiber are usually subject to more polishing than the fiber core typically resulting in a domed shape, such as shown in FIG. 7c, with the center of the fiber extending further than the edge of the optical fiber from the ferrule surface. This is the opposite of core-dip, such as shown in FIG. 7a, which results in less protrusion at the fiber center (core region) than the surrounding fiber cladding area. If polishing conditions are carefully chosen so that the two opposite effects cancel each other a substantially flat core will result such as shown in FIG. 7d. Thus the problematic back cut step can be avoided. Shown in Table 1 is a polishing procedure for 24 fiber Multimode connectors. Steps A1 and A2 of Table 1 is an example of the proximal polishing step shown in block A of FIG. 4. Steps B1 to B4 of Table 1 are examples of the flush polishing step shown in block B of FIG. 4. Step C of Table 1 is an example of the protrusion polish step of block C of FIG. 4. Step D of Table 1 is an example of the cosmetic polishing step of block D of FIG. 4.

### EXAMPLES

Table 1 shows an exemplary set of parameters for carrying out a method of the present invention on a multi-mode fibers.

TABLE 1
Multi-mode 24 fiber MT ferrule polishing procedure (with flat ferrule face polish)

| | | | | | | Polishing | |
|---|---|---|---|---|---|---|---|
| | | | | | | Force (w/o | |
| | | | | | Time | the jig wt.) | Platen Speed |
| Step | Abrasive Type | | Condition | Polish Plate | (sec.) | (lb)/(N) | (RPM) |
| A1 | 30 | μm diamond | Dry | Metallic | NA | By hand | N/A |
| A2 | 15 | μm SIC | Dry | Glass | NA | By hand | N/A |
| B1 | 9 | μm SiC | Wet | Glass | 60 | 3.3/14.7 | 120 |
| B2 | 5 | μm SiC | Wet | Glass | 100 | 3.3/14.7 | 120 |
| B3 | 3 | μm SiC | Wet | Glass | 100 | 3.3/14.7 | 120 |
| B4 | 3 | μm SiC | Wet | Glass | 100 | 3.3/14.7 | 120 |
| C | 1 | μm AlOₓ slurry | 6 cc Slurry | Nylon/Glass | 400 | 10.0/44.5 | 150 |
| D | 0.5 | μm CeO₂ flock | Wet | Glass/Rubber | 150 | 5.0/22.2 | 175 |

Table 2 shows an exemplary set of parameters for carrying out a method of the present invention on single mode fibers.

TABLE 2
Single-mode 24 fiber MT ferrule polishing procedure (with angled ferrule face polish)

| | | | | | | Polishing | |
|---|---|---|---|---|---|---|---|
| | | | | | | Force w/o | |
| | | | | | Time | the jig wt. | Platen Speed |
| Step | Abrasive Type | | Condition | Polish Plate | (sec.) | (lb)/(N) | (RPM) |
| A1 | 30 | μm diamond | Dry | Metallic | NA | By hand | N/A |
| A2 | 6 | μm diamond | Dry | Glass | 30 | 3.3/14.7 | 120 |
| B1 | 9 | μm SiC | Wet | Glass | 60 | 3.3/14.7 | 120 |
| B2 | 5 | μm SiC | Wet | Glass | 100 | 3.3/14.7 | 120 |
| B3 | 3 | μm SiC | Wet | Glass | 100 | 3.3/14.7 | 120 |
| B4 | 3 | μm SiC | Wet | Glass | 100 | 3.3/14.7 | 120 |
| C | 1 | μm AlOₓ slurry | 6 cc Slurry | Nylon/Glass | 400 | 10.0/44.5 | 150 |
| D | 0.5 | μm CeO₂ flock | Wet | Glass/Rubber | 150 | 5.0/22.2 | 175 |

Various modifications and alterations of this invention will become apparent to those skilled in the art without departing from the scope and spirit of this invention and it should be understood that this invention is not to be unduly limited to the illustrative embodiments set forth herein.

We claim:

1. A method comprising:
providing a ferrule assembly having a front side, the front side comprising a ferrule having a front face and at least one optical fiber extending through the ferrule such that an end portion of the at least one optical fiber is exposed through the front face of the ferrule; and
(a) polishing the front side of the ferrule assembly with a particle-loaded lapping film to bring the fibers substantially flush with the ferrule front face;
(b) polishing the front side of the ferrule assembly with at least one slurry to create fiber protrusion;
(c) polishing the front side of the ferrule assembly with at least one flocked film to preferentially etch the at least one optical fiber relative to the front face of the ferrule thereby decreasing the length of the fiber protruding from the ferrule.

2. The method of claim 1, wherein the step of providing a ferrule assembly further comprises the substep of removing any optical fiber portion extending beyond the front face of the ferrule by polishing the front side of the ferrule assembly with a rigid substrate containing diamond particles.

3. The method of claim 2 wherein the substep is carried out as a dry process.

4. The method of claim 1, wherein the flocked film comprises filaments having particles attached thereto.

5. The method of claim 1 wherein step (a) is carried out as a wet process.

6. The method of claim 1, wherein step (a) further comprises a plurality of polishing substeps, each substep using the lapping film with particles having a decreasing or equal average sizes.

7. The method of claim 1, wherein step (a) further comprises the polishing substeps of:
polishing the front face with a lapping film having a first particle type attached thereto;
polishing the front face with a lapping film having a second particle type attached thereto.

8. The method of claim 1, wherein step (b) further comprises a plurality of polishing substeps, each substep using a slurry with particles having a decreasing average size.

9. The method of claim 1, wherein step (b) comprises using a slurry with small diameter particles in combination with using a high polishing force per ferrule.

10. The method of claim 9 wherein the diameter of the particles in the slurry is from about 2 μm to about 0.5 μm.

11. The method of claim 9 wherein the polishing force per ferrule on a plurality of ferrules is from about 0.4 lbs to about 1.2 lbs.

12. The method of claim 1, step (b) further comprises the substeps of:
polishing the front face with a slurry having a first particle type attached thereto;
polishing the front face with a slurry having a second particle type attached thereto.

13. The method of claim 1 wherein step (c) is carried out as a wet process.

14. The method of claim 4 wherein the particles have an average diameter of about 1 μm to about 0.1 μm.

15. An article comprising:
a ferrule assembly having a front side, the front side comprising a ferrule having a front face and at least one multi-mode optical fiber extending through the ferrule, wherein the fiber is made by the method of claim 1 and has a substantially flat core.

16. An article comprising:
at least two mated ferrule assemblies wherein at least one of the ferrule assemblies is a ferrule assembly of claim 15.

17. An article comprising:
at least two mated ferrule assemblies wherein the at least two ferrule assemblies are ferrule assemblies of claim 15.

18. An article comprising:
a fiber optic connector comprising the ferrule assembly of claim 15.

19. An article comprising:
an optical device comprising the ferrule assembly of claim 15.
